(19) United States
(12) Patent Application Publication
(10) Pub. No.: US 2025/0237608 A1
(43) Pub. Date: Jul. 24, 2025

(54) TEST OBJECT ANALYSIS METHOD

(71) Applicant: HAMAMATSU PHOTONICS K.K., Hamamatsu-shi, Shizuoka (JP)

(72) Inventor: Kazuhiko FUJIWARA

(73) Assignee: HAMAMTSU PHOTONICS K.K., Hamamatsu-shi, Shizuoka (JP)

(21) Appl. No.: 18/701,976

(22) PCT Filed: Sep. 8, 2022
(86) PCT No.: PCT/JP2022/033728

§ 371 Date: Apr. 17, 2024

(51) Int. Cl. G01N 21/65; G01N 1/38; G01N 1/44

(52) U.S. Cl. CPC G01N 21/658; G01N 1/38; G01N 1/44; G01N 2201/0612; G01N 2201/0636; G01N 2201/0638

(57) ABSTRACT

An analyte analysis method includes a mixing step of mixing an analyte, a metal ion solution, and a reducing agent to prepare a mixture solution, a metal microstructure generation step of irradiating the mixture solution with light, reducing metal ions in the mixture solution by reducing action of the reducing agent in the mixture solution to generate a metal microstructure on a support, and attaching the analyte or a substance derived from the analyte to the metal microstructure, and a measurement step of irradiating the metal microstructure on the support with excitation light, and measuring a spectrum of Raman scattered light generated by the excitation light irradiation.

### TECHNICAL FIELD

The present disclosure relates to an analyte analysis method.

### BACKGROUND ART

As a method for analyzing an analyte, there has been known a method based on a spectrum of Raman scattered light generated by irradiating the analyte with excitation light. Since the Raman scattering spectrum reflects molecular vibrations of the analyte, it is possible to analyze the analyte based on the shape of the Raman scattering spectrum. However, in this analysis method, the efficiency of Raman scattering is very low in general, and therefore, it is difficult to perform the analysis when an amount of the analyte is very small. For this reason, conventionally, the types of the analytes that can be practically subjected to this analysis method have been limited to substances such as minerals and high density plastics.

On the other hand, surface enhanced Raman scattering (SERS) spectroscopy has a significantly improved Raman scattering efficiency, and is capable of high sensitivity measurement, and thus, it is expected to be capable of analyzing a low concentration sample and it attracts attention. In the SERS spectroscopy, high intensity Raman scattered light can be generated from the analyte, in the case in which two principal conditions are satisfied, that is, an enhanced electric field (photon field) is generated at a metal microstructure irradiated with the excitation light (a first condition), and the analyte constantly exists in the immediate vicinity of the metal microstructure at which the enhanced electric field arrives (a second condition).

In order to efficiently satisfy the first condition, a technique including use of a metal microstructure array designed to have various shapes of nanometer-order size has been proposed, in this method, the analyte is analyzed by the SERS spectroscopy by using a substrate (SERS substrate) having a surface provided with the metal microstructure array, and for example, dropping the analyte onto the SERS substrate. Further, there has been proposed another technique of using a dispersion liquid containing metal colloids (for example, silver colloid particles, gold colloid particles) dispersed therein, in this method, the analyte is analyzed by the SERS spectroscopy by putting the analyte into the metal colloid dispersion liquid.

It is necessary to satisfy the above second condition to analyze the analyte by the SERS spectroscopy, in the case of using the SERS substrate and also in the case of using the metal colloid dispersion liquid. That is, the enhanced electric field can be achieved in a spatially limited area depending on the metal microstructure, and in many cases, the above area exists in a gap in the metal microstructure. Therefore, in order to efficiently generate the SERS light by satisfying also the second condition, the analyte needs to exist in the limited gap.

In Non Patent Document 1, it is reported that, when the Raman scattering spectrum of the analyte (pyridine, biotin, sodium citrate) is measured in the presence of silver ions, a spectrum similar to that obtained by measuring the analyte in the presence of silver colloids is obtained. Further, in this document, it is described that it is assumed that the silver colloids are generated by the irradiation of visible light (Ar ion laser light).

In Non Patent Document 2, it is reported that, when a mixture solution of an aqueous silver nitrate solution and a reducing agent (citric acid) is irradiated with visible light, silver colloids are generated, and that the SERS spectrum of the analyte (pyridine, caffeine) is measured by using the silver colloids.

### CITATION LIST

### Non Patent Literature

Non Patent Document 1: Ahern, A. M.; Garrell, R. L., “In Situ Photoreduced Silver Nitrate as a Substrate for Surface-Enhanced Raman Spectroscopy”, Analytical Chemistry, 59, pp. 2813-2816 (1987)
Non Patent Document 2: Sato-Berru, R.; Redon, R.; Vazquez-Olmos, A.; Saniger, J. M., “Silver nanoparticles synthesized by direct photoreduction of metal salts. Application in surface-enhanced Raman spectroscopy”, Journal of Raman Spectroscopy, 40, pp. 376-380 (2009)
Non Patent Document 3: Mosier-Boss, P. A., “Review on SERS of Bacteria”, Biosensors 7, 51 (2017)

### SUMMARY OF INVENTION

### Technical Problem

In order to analyze the analyte by the SERS spectroscopy with use of the SERS substrate or the metal colloid dispersion liquid, it is necessary to prepare the SERS substrate or the metal colloid dispersion liquid in advance. The SERS light is efficiently generated particularly with silver (Ag), however, silver is easily oxidized. When an oxide film is formed on a surface of a silver microstructure on the SERS substrate or silver colloids at the time of spectroscopic measurement, it is not possible to efficiently analyze the analyte by the SERS spectroscopy. Further, it is necessary to keep the SERS substrate or the metal colloids uncontaminated until the spectroscopic measurement starts, and thus, it is not easy to handle these.

An object of the present invention is to provide an analyte analysis method capable of easily performing an analysis by highly efficient SERS spectroscopy.

### Solution to Problem

A first aspect of the present invention is an analyte analysis method. The analyte analysis method includes (1) a mixing step of mixing an analyte, a metal ion solution, and a reducing agent to prepare a mixture solution; (2) a metal microstructure generation step of irradiating the mixture solution with light, reducing metal ions in the mixture solution by reducing action of the reducing agent in the mixture solution to generate a metal microstructure on a support, and attaching the analyte or a substance derived from the analyte to the metal microstructure; and (3) a measurement step of irradiating the metal microstructure on the support with excitation light, and measuring a spectrum of Raman scattered light generated by the excitation light irradiation.

A second aspect of the present invention is an analyte analysis method. The analyte analysis method includes (1) a mixing step of mixing a metal ion solution and a reducing agent to prepare a mixture solution; (2) a metal microstructure generation step of irradiating the mixture solution with light, reducing metal ions in the mixture solution by reducing action of the reducing agent in the mixture solution to generate a metal microstructure on a support; (3) an attachment step of attaching an analyte or a substance derived from the analyte to the metal microstructure on the support; and (4) a measurement step of, after the attachment step, irradiating the metal microstructure on the support with excitation light, and measuring a spectrum of Raman scattered light generated by the excitation light irradiation.

### Advantageous Effects of Invention

According to the aspects of the present invention, it is possible to easily perform an analysis by highly efficient SERS spectroscopy.

### BRIEF DESCRIPTION OF DRAWINGS

FIG. 1 is a flowchart of an analyte analysis method according to a first embodiment.

FIG. 2 is a flowchart of a analyte analysis method according to a second embodiment.

FIG. 3 is a diagram showing a light absorption spectrum (dashed line) of an aqueous hydroxylamine hydrochloride solution, and a light absorption spectrum (solid line) of a mixture aqueous solution of hydroxylamine hydrochloride and silver nitrate.

FIG. 4 is a diagram illustrating an optical system of a microspectroscope 1 used for measuring a SERS light spectrum in a measurement step in each example.

FIG. 5 is a diagram showing a SERS light spectrum obtained in a first example.

FIG. 6 is a diagram showing a SERS light spectrum obtained in a second example.

FIG. 7 is diagram showing a microscope image of a metal microstructure prepared in a third example.

FIG. 8 includes (a) a diagram showing a SERS light spectrum obtained in the third example, and (b) a diagram showing a SERS light spectrum of each of adenine, guanine, thymine, and cytosine.

### DESCRIPTION OF EMBODIMENTS

Hereinafter, embodiments of an analyte analysis method will be described in detail with reference to the accompanying drawings. In the description of the drawings, the same elements will be denoted by the same reference signs, and redundant description will be omitted. The present invention is not limited to these examples.

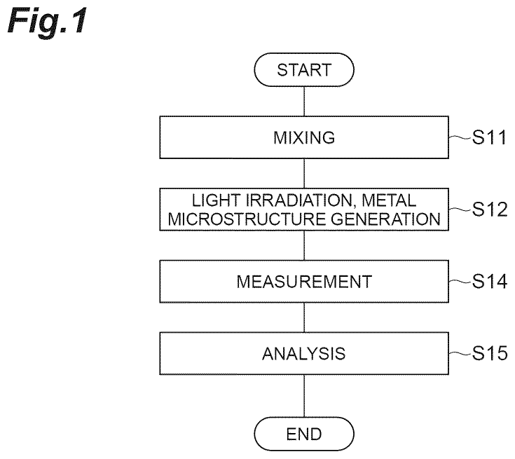

FIG. 1 is a flowchart of an analyte analysis method according to a first embodiment. The analyte analysis method of the first embodiment performs an analysis of an analyte by sequentially performing a mixing step S11, a metal microstructure generation step S12, a measurement step S14, and an analysis step S15. In the analyte analysis method of the first embodiment, a mixture solution containing a measurement solution is prepared in the mixing step S11.

In the mixing step S11, the measurement solution containing the analyte, a metal ion solution, and a reducing agent are sufficiently mixed to prepare a mixture solution. There may be various configurations as a manner or an order of mixing the measurement solution, the metal ion solution, and the reducing agent. Three of the measurement solution, the metal ion solution, and the reducing agent may be simultaneously mixed. Further, any two of the measurement solution, the metal ion solution, and the reducing agent may be mixed to prepare an intermediate mixture solution, and then the remaining one may be mixed with the intermediate mixture solution to prepare a final mixture solution.

The analyte may be any substance regardless of the presence or absence of reducing action, and may be, for example, adenine, guanine, thymine, cytosine, 4,4′-bipyridyl, or the like, or further may be a cell. The metal ion may be any substance as long as it can be reduced by the reducing action of the reducing agent, and may be, for example, a gold ion, a silver ion, or the like.

The reducing agent may be, for example, an aqueous glucose solution, an aqueous iron (II) sulfate solution, an aqueous sodium borohydride solution, an aqueous formaldehyde solution, an aqueous hydroxylamine hydrochloride solution, or the like. The amount and the concentration of each of the metal ion solution and the reducing agent being mixed to prepare the final mixture solution are adjusted appropriately according to the amount of the measurement solution and the concentration of the analyte in the measurement solution.

In the metal microstructure generation step S12, the mixture solution is irradiated with light, and the metal ions in the mixture solution are reduced by the reducing action of the reducing agent in the mixture solution, so that a metal microstructure is generated on a support, and further, the analyte or a substance derived from the analyte is attached to the metal microstructure. The metal microstructure on the support is a structure in which aggregates of deposited metal microparticles are distributed on the support in the form of islands. In this step, in order to prevent evaporation of the mixture solution, the support is preferably allowed to stand still for a predetermined time in a humidified environment.

The support may be a container used in preparation of the intermediate mixture solution or the mixture solution, and further, the support may be a container or a substrate which is prepared separately from the above container, and the substrate may be, for example, a glass slide. Further, a glass slide subjected to a water repellent treatment with a predetermined pattern may be used, and the mixture solution may be prepared in an area on the glass slide which is not subjected to the water repellent treatment to generate the metal microstructure.

In the metal microstructure generation step S12, ultraviolet light or visible light may be used as the light with which the mixture solution is irradiated. When the ultraviolet light having a short wavelength of 400 nm or less is used, as compared with the case in which the visible light is used, the metal ions can be efficiently reduced by the irradiation of low power light in a short time. Further, it is preferable that the light with which the mixture solution is irradiated has a wavelength of 200 nm or more.

After the metal microstructure generation step S12, a drying step of drying the metal microstructure on the support may be performed, and further, a washing step of washing the metal microstructure on the support with water (preferably, ultrapure water) may be performed. In the washing step, the solution unnecessary for the measurement in the subsequent measurement step S14 is removed. In addition, the above washing step may not be performed depending on the sample.

In the measurement step S14, the metal microstructure on the support is irradiated with excitation light, and a spectrum of Raman scattered light generated by the irradiation of the excitation light is measured. A measurement direction of the Raman scattered light with respect to an irradiation direction of the excitation light may be arbitrarily selected, any one of backward scattered light and forward scattered light may be measured, and further, scattered light in any other direction may be measured. Further, it is preferable to provide an optical filter designed to selectively transmit the Raman scattered light in the middle of the measurement optical system.

The excitation light is preferably laser light. An enhanced electric field is generated at the metal microstructure irradiated with the excitation light (the first condition), and the analyte or the substance derived from the analyte is attached to the metal microstructure at which the enhanced electric field arrives (the second condition). Thus, the Raman scattered light to be measured is the SERS light generated from the analyte or the substance derived from the analyte.

In the case in which the metal microstructure is generated in a narrow area on the support, it is preferable to perform the irradiation of the excitation light with use of a microspectroscope and measure the SERS light spectrum. The irradiation of the excitation light and the measurement of the SERS light spectrum may be performed in a state in which the area where the metal microstructure is generated on the support is set to be dry.

In order to prevent the analyte or the substance derived from the analyte being attached to the metal microstructure from being burned out by the excitation light irradiation, it is preferable to immerse the metal microstructure in a liquid (for example, water) on the support, and irradiate the immersed metal microstructure with the excitation light. In this case, a liquid immersion objective lens is preferably used.

In the analysis step S15, the analyte is analyzed based on the spectrum of the Raman scattered light (the SERS light). Specifically, the analyte is analyzed based on the position of the Raman shift amount at which a peak appears and the height of the peak in the obtained SERS light spectrum.

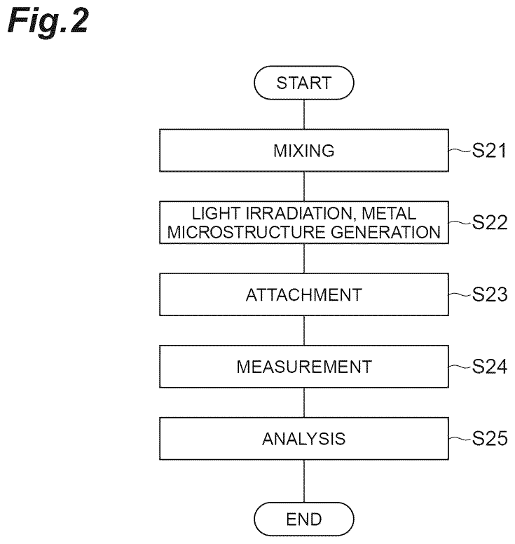

FIG. 2 is a flowchart of the analyte analysis method according to a second embodiment. The analyte analysis method of the second embodiment performs the analysis of the analyte by sequentially performing a mixing step S21, a metal microstructure generation step S22, an attachment step S23, a measurement step S24, and an analysis step S25. In the analyte analysis method of the second embodiment, in the attachment step S23 after the metal microstructure generation step S22, the analyte or the substance derived from the analyte is attached to the metal microstructure on the support. Hereinafter, differences from the analyte analysis method of the first embodiment will be mainly described.

In the mixing step S21, the metal ion solution and the reducing agent are sufficiently mixed to prepare the mixture solution. In the metal microstructure generation step S22, the mixture solution is irradiated with the light, and the metal ions in the mixture solution are reduced by the reducing action of the reducing agent in the mixture solution, so that the metal microstructure is generated on the support.

In the attachment step S23, the analyte or the substance derived from the analyte is attached to the metal microstructure on the support. In addition, before or after the attachment step S23, the drying step of drying the metal microstructure on the support may be performed, and further, the washing step of washing the metal microstructure on the support with water (preferably, ultrapure water) may be performed.

The measurement step S24 in the second embodiment is the same as the measurement step S14 in the first embodiment. The analysis step S25 in the second embodiment is the same as the analysis step S15 in the first embodiment.

Next, the reason why the wavelength of the light with which the mixture solution is irradiated in the metal microstructure generation step S12 or S22 is preferably set to 200 nm or more and 400 nm or less will be described.

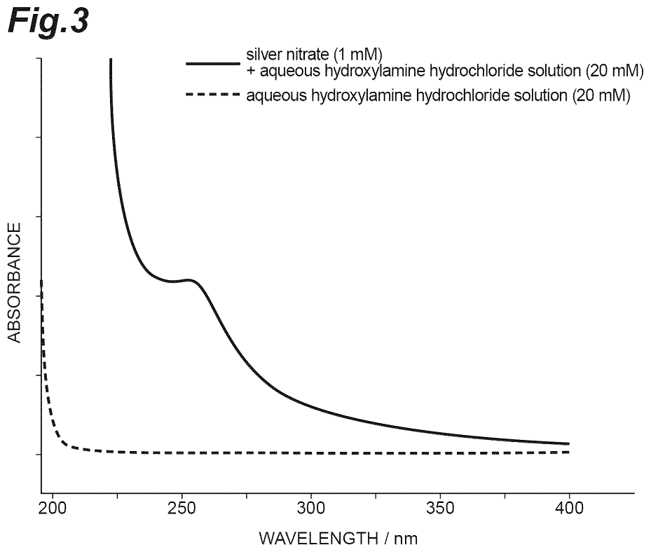

FIG. 3 is a diagram showing a light absorption spectrum (dashed line) of an aqueous hydroxylamine hydrochloride solution, and a light absorption spectrum (solid line) of a mixture aqueous solution of hydroxylamine hydrochloride and silver nitrate. The aqueous hydroxylamine hydrochloride solution is an example of the reducing agent. In the case of hydroxylamine hydrochloride alone, the light absorption is small in a wavelength region shown in the diagram.

On the other hand, in the case of the mixture aqueous solution of hydroxylamine hydrochloride and silver nitrate, the absorbance increases in a wavelength region of 400 nm or less due to the light absorption by silver chloride generated by the mixing. The generation of the metal microstructure by the light irradiation in the metal microstructure generation step S12 or S22 occurs due to the above light absorption by silver chloride.

In addition, the light absorption due to water increases in a wavelength region of less than 200 nm, and thus, it is preferable to irradiate the mixture solution with the light of 200 nm or more. From the above, it is preferable that the wavelength of the light with which the mixture solution is irradiated in the metal microstructure generation step S12 or S22 is set to be 200 nm or more and 400 nm or less.

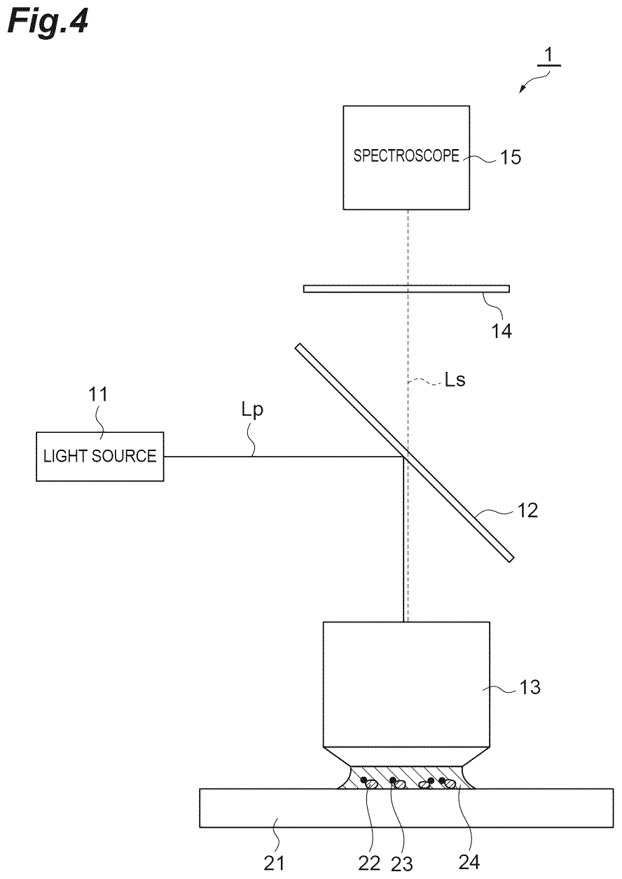

Next, first to third examples will be described. FIG. 4 is a diagram illustrating an optical system of a microspectroscope 1 used at the time of the measurement of the SERS light spectrum in the measurement step in each of the examples. In each example, a glass slide was used as the support used for supporting the metal microstructure. On a surface of the support (glass slide) 21, the metal microstructure 22 in which aggregates of deposited metal microparticles are distributed in the form of islands was formed. The analyte (or the substance derived from the analyte) 23 was attached to the above metal microstructure 22. The metal microstructure 22 and the analyte 23 described above may be immersed in water 24.

A laser diode configured to output laser light having a wavelength of 640 nm as the excitation light L_{P} was used as an excitation light source 11. The excitation light L_{P} output from the excitation light source 11 was reflected by a dichroic mirror 12, and then was transmitted through an objective lens 13 to irradiate the metal microstructure 22 and the analyte 23. The power of the laser light with which the sample surface was irradiated through the objective lens 13 was set to 60 μW.

The Raman scattered light (the SERS light) L_{S} generated in response to the irradiation of the excitation light L_{P} and collected by the objective lens 13 was transmitted through the dichroic mirror 12 and an optical filter 14, and was then incident on a spectroscope 15. The spectroscope 15 was equipped with a cooled CCD detector, and the spectrum of the SERS light was measured by the spectroscope 15.

The procedure of the first example was set according to the flowchart of FIG. 2, and was as follows. An aqueous silver nitrate solution (concentration 5 mM) was used as the metal ion solution, an aqueous hydroxylamine hydrochloride solution (concentration 10 mM) was used as the reducing agent, and an aqueous adenine solution (concentration 10 μM) was used as the measurement solution containing the analyte.

In the mixing step S21, 10 μL of the metal ion solution was dropped onto the glass slide serving as the support, 10 μL of the reducing agent was further dropped onto the dropped spot, and these solutions were mixed on the glass slide.

In the metal microstructure generation step S22, the mixture solution on the glass slide was irradiated with the light output from the LED light source. The wavelength of the light was set to 275 nm, the power was set to about 3 mW, and the irradiation time was set to 20 minutes. By the above light irradiation, silver ions in the mixture solution were reduced by the reducing action of the reducing agent in the mixture solution, aggregates of silver were deposited, and the metal microstructure was generated on the glass slide. Thereafter, the metal microstructure was dried.

In the attachment step S23, 10 μL of the analyte solution was dropped onto the metal microstructure on the glass slide to attach the analyte to the metal microstructure.

In the measurement step S24, the metal microstructure on the glass slide was irradiated with the excitation light (the laser light having a wavelength of 640 nm), and the spectrum of the Raman scattered light (the SERS light) generated by the irradiation of the excitation light was measured.

The procedure of the second example was set according to the flowchart of FIG. 1, and was as follows. An aqueous silver nitrate solution (concentration 5 mM) was used as the metal ion solution, an aqueous hydroxylamine hydrochloride solution (concentration 10 mM) was used as the reducing agent, and an aqueous adenine solution (concentration 10 μM) was used as the measurement solution containing the analyte.

In the mixing step S11, 10 μL of the metal ion solution was dropped onto the glass slide serving as the support, 10 μL of the reducing agent was further dropped onto the dropped spot, and these solutions were mixed on the glass slide. Subsequently, 10 μL of the analyte solution was further dropped onto the dropped spot, and these solutions were mixed on the glass slide.

In the metal microstructure generation step S12, the mixture solution on the glass slide was irradiated with the light output from the LED light source. The wavelength of the light was set to 275 nm, the power was set to about 3 mW, and the irradiation time was set to 20 minutes. By the above light irradiation, silver ions in the mixture solution were reduced by the reducing action of the reducing agent in the mixture solution, aggregates of silver were deposited, and the metal microstructure was generated on the glass slide.

In the measurement step S14, the metal microstructure on the glass slide was irradiated with the excitation light (the laser light having a wavelength of 640 nm), and the spectrum of the Raman scattered light (the SERS light) generated by the irradiation of the excitation light was measured.

The procedure of the third example was set according to the flowchart of FIG. 1, and was as follows. An aqueous silver nitrate solution (concentration 1.0 mM) was used as the metal ion solution, an aqueous hydroxylamine hydrochloride solution (concentration 20 mM) was used as the reducing agent, and a microorganism dispersion liquid was used as the measurement solution containing the analyte. The microorganism dispersion liquid used in this case was obtained by collecting E. coli (DH5a competent cell) being cultured in a liquid culture medium by centrifugation, and dispersing the collected cells in ultrapure water.

In the mixing step S11, 2 μL of the metal ion solution was dropped onto the glass slide serving as the support, 2 μL of the analyte solution was further dropped onto the dropped spot, and these solutions were mixed on the glass slide. Subsequently, 2 μL of the reducing agent was further dropped onto the dropped spot, and these solutions were mixed on the glass slide.

In the metal microstructure generation step S12, the mixture solution on the glass slide was irradiated with the light output from the LED light source. The wavelength of the light was set to 275 nm, the power was set to about 3 mW, and the irradiation time was set to 20 minutes. By the above light irradiation, silver ions in the mixture solution were reduced by the reducing action of the reducing agent in the mixture solution, aggregates of silver were deposited, and the metal microstructure was generated on the glass slide. Thereafter, the metal microstructure was left to dry, and washed with ultrapure water to remove a salt remaining in the reaction mixture.

In the measurement step S14, the metal microstructure on the glass slide was irradiated with the excitation light (the laser light having a wavelength of 640 nm), and the spectrum of the Raman scattered light (the SERS light) generated by the irradiation of the excitation light was measured.

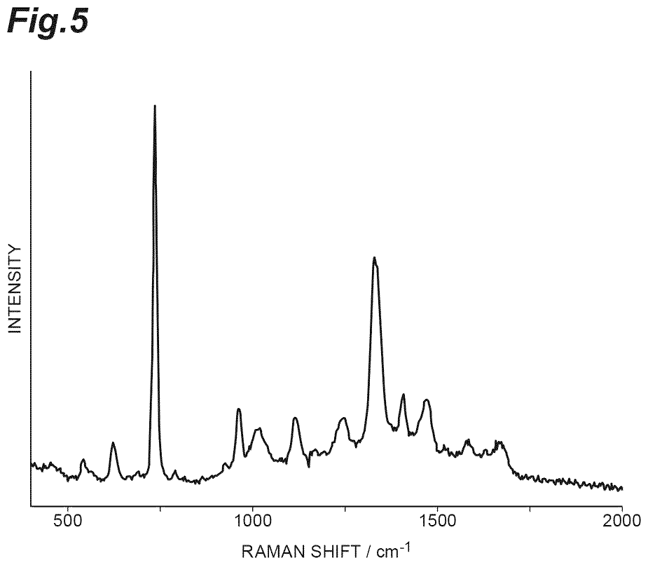

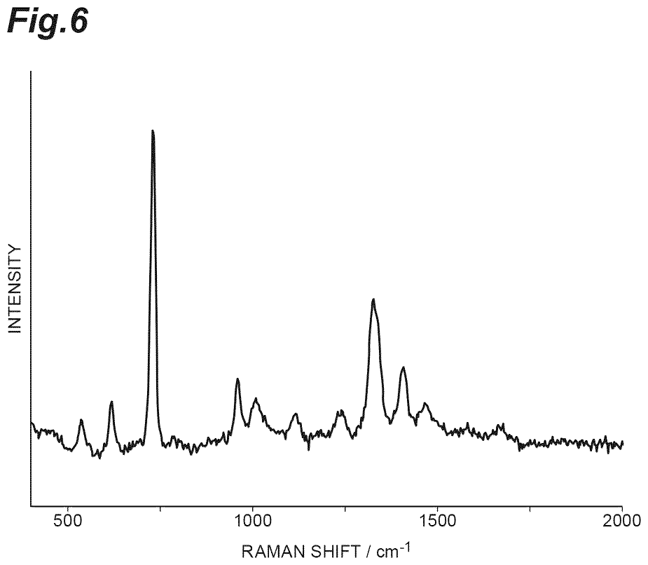

FIG. 5 is a diagram showing the SERS light spectrum obtained in the first example. FIG. 6 is a diagram showing the SERS light spectrum obtained in the second example. In these diagrams, the horizontal axis represents a Raman shift amount (unit: cm⁻¹), and the vertical axis represents a Raman scattering intensity (arbitrary unit). Further, in these diagrams, the SERS light spectra have different zero points on the vertical axis. The same applies to the subsequent diagrams of the SERS light spectra.

As shown in FIG. 5 and FIG. 6, in each of the first and second examples, a peak derived from breathing vibration being characteristic of adenine is observed near the Raman shift amount of 735 nm-1. The SERS light spectrum peculiar to adenine is measured by the analyte analysis method of each of the first embodiment and the second embodiment. Therefore, for example, when the analyte is insoluble in water and dissolved in a non-aqueous solvent or the like, the measurement can be performed by the analyte analysis method of the second embodiment, and when the analyte is soluble in water, the measurement can be performed by the analyte analysis method of the first embodiment.

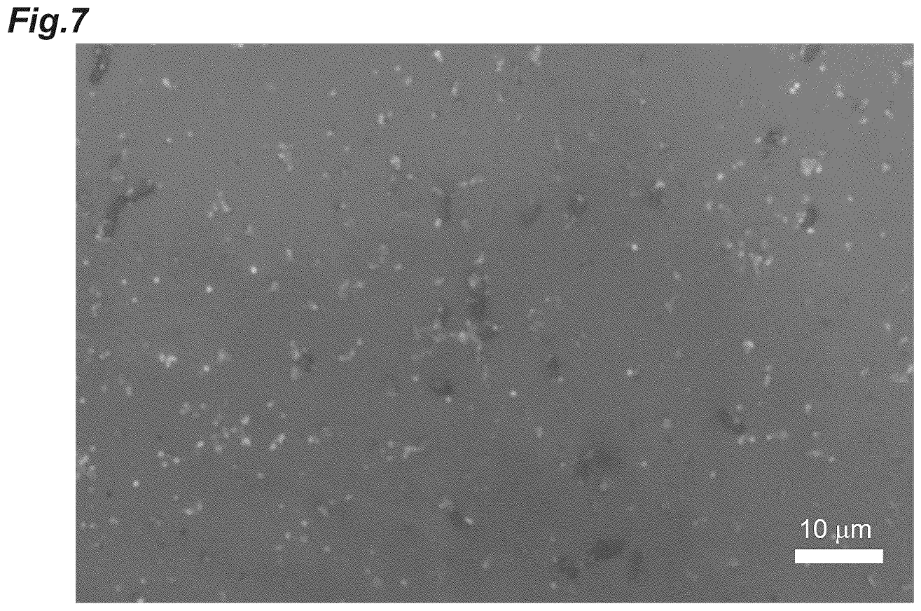

FIG. 7 is a diagram showing a microscope image of the metal microstructure prepared in the third example. In the microscope image, a black portion indicates bacterial cells, and a white portion indicates deposited structures of silver. In the measurement step, an area (center area in the diagram) including a portion where black bacterial cells and white silver structures overlap each other was irradiated with the excitation light, and the spectrum of the SERS light generated by the irradiation of the excitation light was measured.

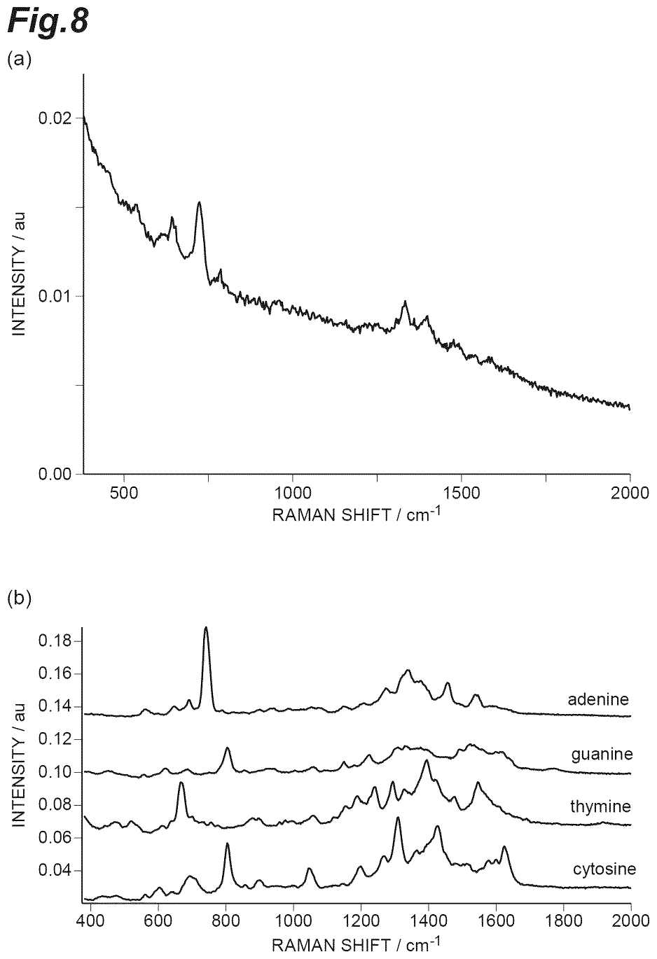

(a) in FIG. 8 is a diagram showing the SERS light spectrum obtained in the third example. (b) in FIG. 8 is a diagram showing the respective SERS light spectra of adenine, guanine, thymine, and cytosine. In the SERS light spectrum obtained in the third example, the peak being characteristic of adenine is also observed near the Raman shift amount of 735 nm⁻¹, as observed in the SERS light spectra of FIG. 5 and FIG. 6. Further, in the SERS light spectrum obtained in the third example, not only adenine, but also peaks being characteristic of guanine, thymine, and cytosine, which are other nucleic acid bases, are also observed.

According to Non Patent Document 3, the SERS light spectrum derived from bacterial cells is obtained by using colloid particles or the like, and the peak in the SERS light spectrum is considered to be derived from nucleic acids contained in the bacterial cells, nucleic acid bases, or metabolites thereof. In the third example, similarly to the SERS spectroscopy technique described in Non Patent Document 3, the SERS light spectrum having the peak due to the substance derived from the nucleic acid is acquired.

As described above, the analyte analysis method of the present embodiment generates the metal microstructure on the support by irradiating the mixture solution with the light, and reducing the metal ions in the mixture solution by the reducing action of the reducing agent in the mixture solution, attaches the analyte or the substance derived from the analyte to the metal microstructure, measures the spectrum of the Raman scattered light (the SERS light) generated by the irradiation of the excitation light thereon, and analyzes the analyte based on the spectrum. As compared with the conventional analysis method, the analyte analysis method according to the present embodiment can perform the analysis easily and quickly.

In the conventional method, the types of the analyte that can be subjected to the SERS spectroscopy are limited to substances that have high affinity for the metal constituting the metal microstructure and that are easy to be adsorbed. On the other hand, in the analyte analysis method of the present embodiment, even when the analyte has low affinity for the metal constituting the metal microstructure and is difficult to be adsorbed, the metal microstructure can be formed, and the analyte or the substance derived from the analyte can enter a narrow gap in the metal microstructure, and thus the second condition can be satisfied, so that the analysis of the analyte by the SERS spectroscopy can be performed.

In the conventional analysis method, it is necessary to prepare the SERS substrate or the metal colloids in advance at the time of the measurement of the SERS light spectrum. On the other hand, in the analyte analysis method of the present embodiment, it is possible to generate the metal microstructure and to attach the analyte (or the substance derived from the analyte) to the metal microstructure immediately before the measurement of the SERS light spectrum. Therefore, in the analyte analysis method of the present embodiment, even in the case in which silver, which is easily oxidized, is used to generate the metal microstructure, it is possible to suppress oxidization of silver, and to perform the efficient SERS spectroscopy

In the analyte analysis method of the present embodiment, it is not necessary to prepare the SERS substrate or the metal colloids in advance, and therefore, it is free from the problem of contamination of these, and thus, the analysis of the analyte can be easily performed. Further, the analyte analysis method of the present embodiment uses the metal ion solution, which is available at a lower cost than the SERS substrate and the metal colloids, and also for this reason, the analysis of the analyte can be easily performed.

In the conventional analysis method including use of the metal colloid dispersion liquid, it is difficult to perform the SERS spectroscopy when an amount of the analyte is very small. On the other hand, in the analyte analysis method of the present embodiment, it is possible to perform the SERS spectroscopy even when the amount of the analyte is very small.

Further, it is preferable to use a pH adjusting agent in the conventional method, and on the other hand, it is not necessary to use the pH adjusting agent in the analyte analysis method of the present embodiment. Therefore, in the analyte analysis method of the present embodiment, the pH fluctuation in the sample is suppressed, and thus, it is possible to cope with the analysis of the analyte which may be changed or decomposed due to the pH fluctuation. Further, the analyte analysis method of the present embodiment which does not use the pH adjusting agent also reduces an amount of chemicals used, and thus, can be said to be good for the environment.

The analyte analysis method is not limited to the embodiments and configuration examples described above, and can be modified in various ways.

The analyte analysis method of the first aspect of the above embodiment includes (1) a mixing step of mixing an analyte, a metal ion solution, and a reducing agent to prepare a mixture solution; (2) a metal microstructure generation step of irradiating the mixture solution with light, reducing metal ions in the mixture solution by reducing action of the reducing agent in the mixture solution to generate a metal microstructure on a support, and attaching the analyte or a substance derived from the analyte to the metal microstructure; and (3) a measurement step of irradiating the metal microstructure on the support with excitation light, and measuring a spectrum of Raman scattered light generated by the excitation light irradiation.

The analyte analysis method of the second aspect of the above embodiment includes (1) a mixing step of mixing a metal ion solution and a reducing agent to prepare a mixture solution; (2) a metal microstructure generation step of irradiating the mixture solution with light, and reducing metal ions in the mixture solution by reducing action of the reducing agent in the mixture solution to generate a metal microstructure on a support; (3) an attachment step of attaching an analyte or a substance derived from the analyte to the metal microstructure on the support; and (4) a measurement step of, after the attachment step, irradiating the metal microstructure on the support with excitation light, and measuring a spectrum of Raman scattered light generated by the excitation light irradiation.

In the above analyte analysis method of the first or second aspect, in the metal microstructure generation step, the mixture solution may be irradiated with the light having a wavelength of 200 nm or more and 400 nm or less.

### INDUSTRIAL APPLICABILITY

The present invention can be used as an analyte analysis method capable of easily performing an analysis by highly efficient SERS spectroscopy.

### REFERENCE SIGNS LIST

1—microspectroscope, 11—excitation light source, 12—dichroic mirror, 13—objective lens, 14—optical filter, 15—spectroscope, 21—support, 22—metal microstructure, 23—analyte (or substance derived from analyte), 24—water.

1. An analyte analysis method comprising:
a mixing step of mixing an analyte, a metal ion solution, and a reducing agent to prepare a mixture solution;
a metal microstructure generation step of irradiating the mixture solution with light, reducing metal ions in the mixture solution by reducing action of the reducing agent in the mixture solution to generate a metal microstructure on a support, and attaching the analyte or a substance derived from the analyte to the metal microstructure; and
a measurement step of irradiating the metal microstructure on the support with excitation light, and measuring a spectrum of Raman scattered light generated by the excitation light irradiation.

2. An analyte analysis method comprising:
a mixing step of mixing a metal ion solution and a reducing agent to prepare a mixture solution;
a metal microstructure generation step of irradiating the mixture solution with light, and reducing metal ions in the mixture solution by reducing action of the reducing agent in the mixture solution to generate a metal microstructure on a support;
an attachment step of attaching an analyte or a substance derived from the analyte to the metal microstructure on the support; and
a measurement step of, after the attachment step, irradiating the metal microstructure on the support with excitation light, and measuring a spectrum of Raman scattered light generated by the excitation light irradiation.

3. The analyte analysis method according to claim 1, wherein, in the metal microstructure generation step, the mixture solution is irradiated with the light having a wavelength of 200 nm or more and 400 nm or less.

4. The analyte analysis method according to claim 2, wherein, in the metal microstructure generation step, the mixture solution is irradiated with the light having a wavelength of 200 nm or more and 400 nm or less.
